(19) United States
(12) Patent Application Publication
(10) Pub. No.: US 2008/0239222 A1
(43) Pub. Date: Oct. 2, 2008

(54) Substrate for liquid crystal display device and fabrication method thereof

(75) Inventors: Shusaku Naitoh, Kobe (JP); Hitoshi Okada, Kobe (JP)

Correspondence Address: LIU & LIU, 444 S. FLOWER STREET, SUITE 1750, LOS ANGELES, CA, 90071, US

(73) Assignee: TPO Displays Corp.

(21) Appl. No.: 12/077,699

(22) Filed: Mar. 19, 2008

(30) Foreign Application Priority Data
Mar. 28, 2007 (JP) 2007-085248

(51) Int. Cl. G02F 1/1337; G02F 1/13

(52) U.S. Cl. 349/123; 349/187

(57) ABSTRACT

A substrate for a liquid crystal display device having a structure capable of preventing fur of the rubbing roller from being in disorder, and a fabrication method thereof is disclosed.

One embodiment of a substrate for a liquid crystal display device and a fabrication method thereof discloses an alignment film is formed over the transparent common electrode and boundary portions thereof. The transparent common electrode is formed on a transparent substrate.

### BACKGROUND OF THE INVENTION

1. Field of the Invention

The present invention relates to a substrate for a liquid crystal display device and a fabrication method thereof, and in particular, relates to a structure over a transparent substrate constituting a liquid crystal cell of a liquid crystal display device and a fabrication method thereof.

2. Description of the Related Art

For a conventional manufacturing process of a liquid crystal display device, a rubbing treatment is performed, in a certain direction, on an alignment film over the transparent substrate constituting a liquid crystal cell to align liquid crystal molecules in a prescribed direction. The rubbing treatment employs rubbing cloth such as felt or cotton.

The rubbing treatment is performed by rotating and lowering the rubbing roller with rubbing cloth thereon to contact the surface of the alignment film over the transparent substrate. Specifically, the transparent substrate moves in a direction inverse to or inclining to the rotation direction of the rubbing roller fixed in an appropriate position. In another embodiment, the rotating rubbing roller passes across fixed transparent substrates in any desirable direction.

Because uniformity of the rubbing treatment plays an important role in the alignment state of liquid crystal molecules, particularly, a direct influence on display quality of the liquid crystal display device, performing a uniformed rubbing treatment well across the alignment film is very important.

For example, a rubbing treatment and a rubbing device for a liquid crystal display device are disclosed in JP 2002-006322. To ensure uniformity of the rubbing treatment, rubbing strength is adjusted depending on a shift angle θ of the rubbing roller deviating from a position where axis of the rubbing roller and movement direction of the substrate are perpendicular to one another.

However, the rubbing treatment and rubbing device for a liquid crystal display device employed in JP 2002-006322 still can not solve problems such as unevenness of the rubbing treatment.

Such issue i.e. unevenness of the rubbing treatment is to be described later.

FIG. 2 is a top view of a portion of a structure over a transparent substrate for a liquid crystal display device, illustrating issues for a conventional rubbing treatment.

Transparent common electrode 20 is formed on the transparent substrate prior to the rubbing treatment. Furthermore, an alignment film 10 is formed over a display region of the transparent common electrode 20. Thereafter, a protruding portion 20a where a common electrode contact point is to be located later, is formed over the transparent common electrode 20.

During the rubbing treatment of the alignment film 10, the rubbing roller with rubbing cloth thereon is rotated and lowered to contact the transparent substrate 30. The rubbing roller has a motion relative to the transparent substrate 30, for example, the rubbing roller moves in the rubbing direction. In doing so, the rubbing treatment is performed to rub the whole surface of the alignment film 10 by the rubbing roller.

When the rubbing roller passes surroundings of the transparent common electrode 20 i.e. the boundary portion between the transparent common electrode 20 and the surface 30s of the transparent substrate 30, fur of a rubbing roller often disorders.

The boundary portion between the transparent common electrode 20 and the surface 30s of the transparent substrate 30 is where the transparent common electrode 20 of a conductor and the transparent substrate 30 of an insulator adjoin. As result, fur of a rubbing roller easily disorders.

Specifically, fur of the rubbing roller disorders more easily in a corner portion 20c of the transparent common electrode 20 due to the formation of a protruding portion 20a of the transparent common electrode 20.

FIG. 3 is a schematic view showing that fur of a rubbing roller is disordered when the rubbing roller passes surroundings of the transparent common electrode. FIG. 3 a shows the state when the rubbing roller passes a position which is in line AA′ of FIG. 2, and FIG. 3 b shows the state when the rubbing roller passes a position which is in line BB′ of FIG. 2.

As shown in FIG. 3a, because the transparent common electrode 20 of a conductor and the transparent substrate 30 of an insulator give different electrostatic charges to a first region 4P1 and a second region 4P2 of the fur 4P of the rubbing roller 40, fur of the first region 4P1 is in a state different from that of the second region 4P2.

Therefore, in the boundary portion between the transparent common electrode 20 and the surface 30s of the transparent substrate 30 i.e. the part over the surrounding of the transparent common electrode 20, fur of the first region 4P1 comes in contact with that of the second region 4P2, resulting in disorder 4Q of fur 4P of the rubbing roller 40.

As shown in FIG. 3 b, disorder 4Q of fur does not disappear, even after the rubbing roller 40 passes over a boundary portion 20e of the transparent common electrode 20 and enters over a portion of the alignment film 10. Consequently, as shown in FIG. 2, a defect M is formed on the surface of the alignment film 10.

The defect M formed on the surface of the alignment film 10 worsens uniformity of the rubbing treatment, and makes alignment state of the liquid crystal molecules irregular. As a result, uniformity of display quality of the liquid crystal display device degrades, and display mura takes place.

In view of the described problems, a substrate for a liquid crystal display device having a structure capable of preventing fur of the rubbing roller from being in disorder is desirable and so is a fabrication method thereof.

### BRIEF SUMMARY OF THE INVENTION

According to one embodiment of the invention, a substrate for a liquid crystal display device is disclosed. The device comprises a transparent insulating substrate, a transparent common electrode formed on the transparent substrate, and an alignment film formed over the transparent common electrode and boundary portions thereof.

According to another embodiment of the invention, a fabrication method for a substrate for a liquid crystal display device is disclosed. The fabrication method comprises a step of forming a transparent common electrode on a transparent substrate, a step of forming an alignment film over the transparent common electrode and boundary portions thereof.

By employing the described structure, embodiments of the invention prevent fur of the rubbing roller from being in disorder during the rubbing treatment, thus, ensuring uniformity of the rubbing treatment. As result, a liquid crystal display device with good display quality is obtained.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1a-1b are top views of an embodiment of a substrate for a liquid crystal display device and a fabrication method thereof of the invention.

FIG. 2 is a top view of a portion of a structure over a transparent substrate for a liquid crystal display device, illustrating issues for a conventional rubbing treatment.

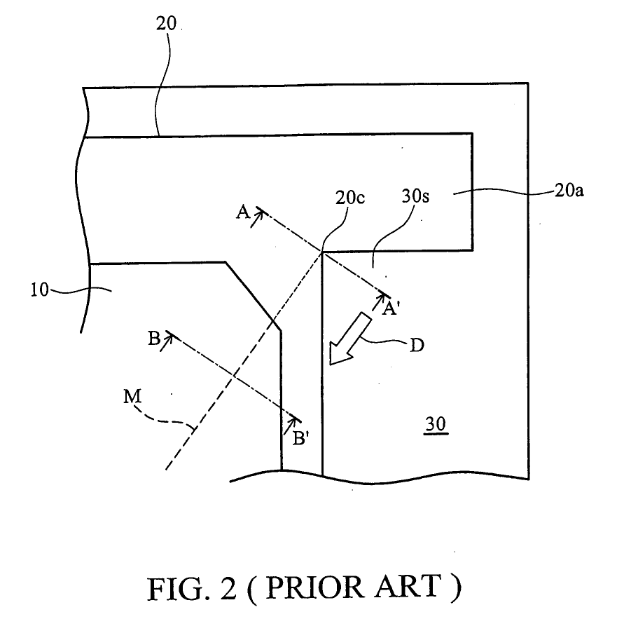

FIGS. 3a-3b are s schematic views showing that fur of a rubbing roller is disordered when the rubbing roller passes surroundings of the transparent common electrode.

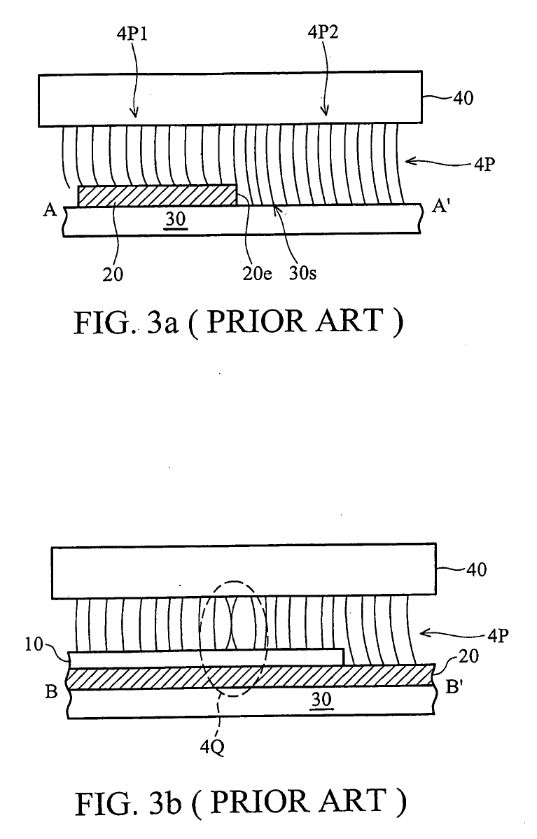

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A detailed description is given in one embodiment relating to a substrate for a liquid crystal display device and a fabrication method thereof of the invention, with reference to the accompanying drawings.

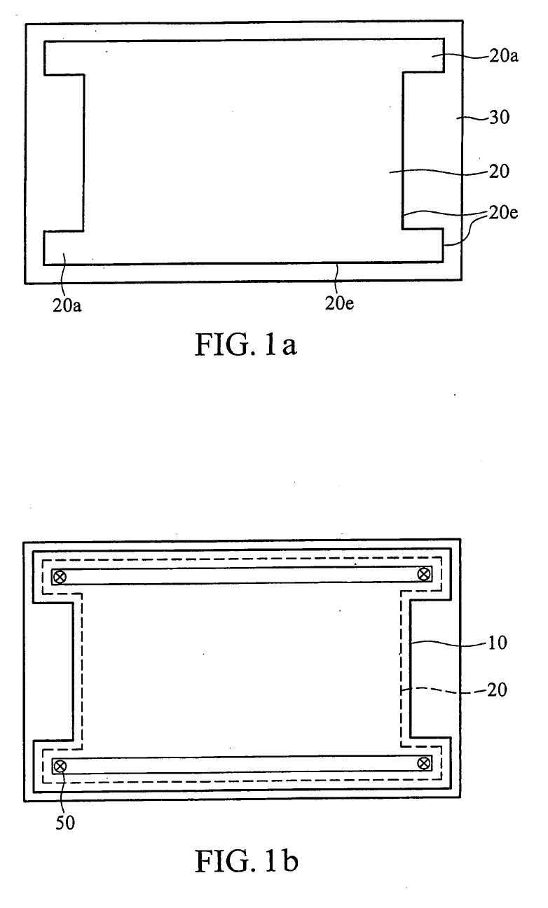

FIGS. 1a-1b are top views of an embodiment of a substrate for a liquid crystal display device and a fabrication method thereof of the invention.

FIG. 1a is a top view of an embodiment of a method for fabricating a substrate for a liquid crystal display device of the invention. FIG. 1b is a top view of an embodiment of a structure of a substrate for a liquid crystal display device of the invention.

In the method for fabricating a substrate for a liquid crystal display device, as shown in FIG. 1a, a transparent common electrode 20 is formed on a transparent substrate 30, such as a glass substrate. The transparent common electrode 20 is made up of indium tin oxide, for example. Furthermore, a common potential is given to the transparent common electrode 20 when driving a liquid crystal display device.

Thereafter, a protruding portion 20a where a common electrode contact point 50 is to be located later is formed over the transparent common electrode 20.

As shown in FIG. 1b, this embodiment of a substrate for a liquid crystal display device and a fabrication method thereof of the invention, features an alignment film 10, formed over the transparent common electrode 20 and boundary portions 20e thereof.

The transparent substrate 30 is an insulator. Furthermore, the alignment film 10, for example, made up of polyimide, is also a resin film i.e. an insulator. Although the transparent common electrode 20 is a conductor, the transparent common electrode 20 and boundary portions 20e thereof are covered by the alignment film 10 i.e. an insulator.

Therefore, in this embodiment of a substrate for a liquid crystal display device and a fabrication method thereof of the invention, the entire surface of the structure of the substrate is an insulator, when subjected to the rubbing treatment, thus, there is no boundary portion between the insulator and conductor on the substrate.

As previously described, disorder of fur of the rubbing roller during the rubbing treatment is mainly caused by the existence of a boundary portion between the insulator and conductor. That is, in the opposite sides of the boundary portion, different electrostatic charges are given to fur of the rubbing roller, thus, causing fur of the rubbing roller passing the boundary portion to be disorderly.

However, in this embodiment of a substrate for a liquid crystal display device and a fabrication method thereof of the invention, the previously described issues in prior art do not take place because there is no boundary portion between the insulator and conductor on the substrate when being subjected to the rubbing treatment.

According to embodiments of the invention, fur of the rubbing roller is prevented from being in disorder during the rubbing treatment, thus, ensuring uniformity of the rubbing treatment. As result, a liquid crystal display device with good display quality is obtained.

The embodiment of a substrate for a liquid crystal display device and a fabrication method thereof of the invention features an alignment film 10, formed over the transparent common electrode 20 and boundary portions 20e thereof, wherein the transparent common electrode 20 and alignment film 10 can be formed of any shape. In another embodiment of the invention, protruding portion 20a of the transparent common electrode 20 can be omitted.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A substrate for a liquid crystal display device, comprising:
a transparent substrate;
a transparent common electrode formed on the transparent substrate; and
an alignment film formed over the transparent common electrode and boundary portions thereof.

2. The substrate for a liquid crystal display device as claimed in claim 1, wherein the transparent common electrode includes a protruding portion where a common electrode contact point is to be located, and the alignment film is formed over the protruding portion and boundary portions thereof.

3. The substrate for a liquid crystal display device as claimed in claim 1, wherein the alignment film is a resin film.

4. The substrate for a liquid crystal display device as claimed in claim 1, wherein the alignment film is a polyimide film.

5. A fabrication method for a substrate for a liquid crystal display device, comprising:
forming a transparent common electrode on a transparent substrate; and
forming an alignment film over the transparent common electrode and boundary portions thereof.

6. The fabrication method as claimed in claim 5, wherein the transparent common electrode includes a protruding portion where a common electrode contact point is to be located, and the alignment film is formed over the protruding portion and boundary portions thereof.
